(19) United States
(12) Patent Application Publication
(10) Pub. No.: US 2019/0325513 A1
(43) Pub. Date: Oct. 24, 2019

(54) SYSTEM AND METHOD FOR GENERATING A DYNAMIC LOAN-TO-VALUE RATIO

(71) Applicant: Stoa Fund Ltd., Tel Aviv (IL)

(72) Inventors: Or AGASSI, Tel Aviv (IL); Tom SELLA, Miami, FL (US); Jonathan SARAGOSSI, Tel Aviv (IL)

(73) Assignee: Stoa Fund Ltd., Tel Aviv (IL)

(21) Appl. No.: 16/391,617

(22) Filed: Apr. 23, 2019

Related U.S. Application Data
(60) Provisional application No. 62/661,687, filed on Apr. 24, 2018.

(51) Int. Cl. G06Q 40/02; G06F 16/9537; G06F 16/908; G06F 16/903; G06F 16/906

(52) U.S. Cl. CPC G06Q 40/025; G06F 16/9537; G06Q 50/16; G06F 16/90335; G06F 16/906; G06F 16/908

(57) ABSTRACT

A system and method for determining the value of a real estate property (REP) throughout a rehab process. The method includes: receiving at least one location pointer associated with the at least one REP; extracting metadata associated with the at least one REP from at least one web source; determining a current evaluation of the REP based on the extracted metadata; receiving at least one rehab objective; analyzing the at least one rehab objective to determine the effect of the at least one rehab objective on the value of the property; and determining a projected evaluation based on the analysis.

### CROSS-REFERENCE TO RELATED APPLICATIONS

This application claims the benefit of U.S. Provisional Application No. 62/661,687 filed on Apr. 24, 2018, the contents of which are hereby incorporated by reference.

### TECHNICAL FIELD

The present disclosure relates generally to real estate assessment tools, and more specifically to a system and methods for automatically and dynamically evaluating a real estate property throughout a rehab process.

### BACKGROUND

In real estate, loan-to-value (LTV) ratio is a financial term used by lenders to express the ratio of a loan to the value of an asset being purchased. A common approach in understanding an LTV is that the higher the LTV ratio, the riskier the loan is for a lender.

In some cases, loans are originated in two tiers—one for the purchase of a property, and the other for rehab financing for rehabilitating a property in need of repairs. The loan is typically secured by a first mortgage. The rehab portion is put aside until the objectives have been accomplished. For example, in case a paintjob is required and confirmed, the loan portion designated for the paintjob is held back and paid only upon completion of the paintjob, at the lender's sole discretion.

The holdback mechanism should decrease lender exposure, but in many cases it is not enough to secure the loan and may increase the LTV ratio. The rehab process typically includes multiple objectives, where some objectives immediately increase the property value and some do not.

As an example, in case a lender is willing to provide 70% LTV for a property at a purchase price of $100,000, the loan provided will be $70,000. The rehab objectives may include tiles replacement, demolition of walls and refurbishment of the kitchen. If the rehab starts with demolition, upon completion, the value of the property has not increased, and therefore, if the borrower defaults after the demolition, the exposure of the lender is higher than the 70% LTV. However, upon completion of the refurbish of the kitchen, the value of the property may substantially be increased and the exposure can be lower than 70% LTV.

It can be difficult to determine in advance the various and varying values of a property throughout a rehab processes. Such information is essential for a lender to have to decide which loans to approve and which to decline.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for determining the value of a real estate property (REP) throughout a rehab process, including: receiving at least one location pointer associated with the at least one REP; extracting metadata associated with the at least one REP from at least one web source; determining a current evaluation of the REP based on the extracted metadata; receiving at least one rehab objective; analyzing the at least one rehab objective to determine the effect of the at least one rehab objective on the value of the property; and determining a projected evaluation based on the analysis.

Certain embodiments disclosed herein also include a non-transitory computer readable medium having stored thereon instructions for causing a processing circuitry to perform a process, the process including: receiving at least one location pointer associated with the at least one REP; extracting metadata associated with the at least one REP from at least one web source; determining a current evaluation of the REP based on the extracted metadata; receiving at least one rehab objective; analyzing the at least one rehab objective to determine the effect of the at least one rehab objective on the value of the property; and determining a projected evaluation based on the analysis.

Certain embodiments disclosed herein also include a system for determining the value of a real estate property (REP) throughout a rehab process, including: a processing circuitry; and a memory, the memory containing instructions that, when executed by the processing circuitry, configure the system to: receive at least one location pointer associated with the at least one REP; extract metadata associated with the at least one REP from at least one web source; determine a current evaluation of the REP based on the extracted metadata; receive at least one rehab objective; analyze the at least one rehab objective to determine the effect of the at least one rehab objective on the value of the property; and determine a projected evaluation based on the analysis.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a block diagram of a real estate evaluation system according to an embodiment.

FIG. 2 is an example flowchart illustrating a method for dynamically evaluating real estate properties throughout rehab processes according to an embodiment.

FIG. 3 is an example flowchart describing a method for determining the effect of the objective process and completion on the value of the at least one real estate property.

FIG. 4 is a graph of a value behavior of a real estate property throughout rehab according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

A system is used for dynamically determining changes in property value throughout a rehab process. By receiving metadata associated with the property and a plurality of objectives to be achieved throughout the rehab, the system determines an effect of each objective on the value of the property.

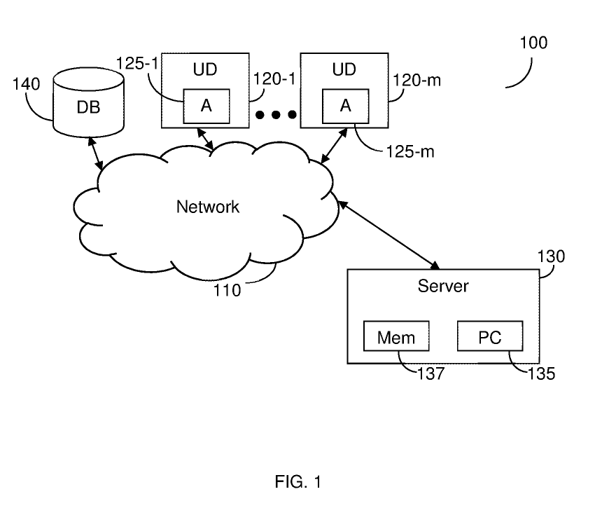

FIG. 1 is an exemplary and non-limiting block diagram of a property future evaluation system 100 according to an embodiment. A network 110 is used to communicate between different parts of the system 100. The network 110 may be the Internet, the world-wide-web (WWW), a local area network (LAN), a wide area network (WAN), a metro area network (MAN), and other networks capable of enabling communication between the elements of the system 100.

Optionally, one or more user devices 120-1 through 120-m, where ‘m’ is an integer equal to or greater than 1, and hereinafter referred to as user device 120, are further connected to the network 110. A user device 120 may be, for example, a personal computer (PC), a personal digital assistant (PDA), a mobile phone, a smart phone, a tablet computer, an electronic wearable device (e.g., glasses, a watch, etc.) and other kinds of wired and mobile appliances, equipped with browsing, viewing, capturing, storing, listening, filtering, and managing capabilities enabled as further discussed herein below.

Each user device 120 may further include a software application (App) 125 installed thereon. A software application (App) 125 may be downloaded from an application repository, such as the Apple AppStore®, Google Play®, or any repositories hosting software applications. The application 125 may be pre-installed in the user device 120. In one embodiment, the application 125 is a web-browser.

A server 130 is coupled to the user device 120 and can communicate therewith using the application 125 via the network 110. The server 130 typically comprises a processing circuitry 135 and a memory 137. The memory 137 contains therein instructions that, when executed by the processing circuitry 135, configure the server 130 as further described hereinabove and below. The server 130 also includes a network interface (not shown) configured to connect to the network 110.

It should be noted that only one user device 120 and one application 125 are discussed herein merely for the sake of simplicity. However, the embodiments disclosed herein are applicable to a plurality of user devices and applications that can communicate with the server 130 via the network 110.

Also connected to the network 110 is a database 140 that stores metadata related to certain property transactions, data extracted from regulatory data sources and/or tax authorities, geographic information systems (GISs), home appliance retailers, and more. In the embodiment illustrated in FIG. 1, the server 130 communicatively communicates with the database 140 via the network 110.

According to an embodiment, the server 130 receives at least one location pointer associated with at least one real estate property (REP). The location pointer may be received from a user device 120, via for example, the agent 125. The location pointer may be, for example, an address or a portion thereof, a geo-location, and similar parameters configured to locate a property.

Thereafter, the server 130 is configured to extract metadata associated with the at least one REP from at least one web source over the network 110. The metadata may include at least one of: parameters associated with previous transactions made with respect to one or more second REPs determined as associated to the at least one REP, one or more second REPs in proximity to the at least one REP, previous transaction made with respect to the at least one REP, data regarding rehabs made with respect to the REP, and the like. The metadata may be extracted from, for example, governmental website via the network 110, real estate comparison websites, such as, for example, Zillow®, combination thereof, etc.

One or more second REPs may be determined as associated to the at least one REP based on metadata such as for example, year built, number of rooms and/or bathrooms, size e.g., square feet, demographic data, nearby crime rates, proximity to certain venues and attractions, weather data, and the like.

According to an embodiment, the server 130 is further configured to extract at least one multimedia content element associated with the at least one REP. The multimedia content element may be an overhead image of the REP location one image of a map associated with the REP. Such images may be retrieved from sources such as Google® maps, Zillow, and the like.

In an embodiment, the database 140 is configured to store a plurality of multimedia contents related to the REP, such as map images. Thereafter, a surface outline of a surface, e.g., a rooftop of the REP, is identified. A pattern associated with the outlined surface is then determined by the server 130. Based on the multimedia content element, the server 130 identifies venues located in proximity to the REP, e.g., within a predefined maximum distance. The venues may include, for example, commercial venues, community venues, and the like. The server 130 is further configured to determine the proximity of the venues to the REP.

The server 130 is further configured to identify a subdivision in which the REP is located. According to an embodiment, the server 130 is further configured to determine at least one view characteristic from the at least one REP based on the multimedia content element. Examples of a view characteristic include a wall of an adjacent REP, an unobstructed view, a view of a downtown scene, and the like. Additionally, the server 130 may be configured to determine size parameters, e.g. square feet associated with the REP, e.g., based on a determined building size and number of stories estimated based on the multimedia content element.

Based on the collected information about the REP, the server 130 is configured to determine a current valuation of the REP. The current valuation represents the as-is value (AIV) of the REP. This valuation may be based on comps, or comparable REPs that have been sold and purchased recently. Comp REPs having characteristics similar to the REP within a predetermined threshold may be used as a value reference, whereas REPs lying outside such a threshold are ignored. Thresholds may be based on square footage, lot size, age of REP, rooms, style of REP, and similar parameters.

Upon receiving a rehab objective, the server 130 is configured to determine its effect on the value of the REP. A rehab process consists of one or more objectives. The rehab objective is a task to be completed as part of a rehab process, e.g., paint, purchase of furniture/fixtures, demolition of walls, landscaping, plumbing, etc. Therefore, an objective may be painting all house interiors, replace plumbing in one toilet, etc.

The server 130 is then configured to determine the effect of the objective on the value of the property, throughout and until completion. It should be noted that throughout the objective, the value may decrease and increase upon completion of the objective. Additionally, in an embodiment, the value may decrease at the initial stage of the objective, e.g., demolition stage, and increase at the final stage, e.g., completion of kitchen remodel.

The determination of the effect on the value is made by extracting data associated with similar objectives for which the effect on the value is known, e.g., similar objective completed on comparable REPs. The data may be extracted from a database 140. The data may be associated directly with REPs in proximity to the at least one REP, i.e., demographically, geographically, and the like.

Based on an analysis of the data, the server 130 determines the effect of the objective on the REP throughout the process and until completion. Respective thereof, the server 130 is configured to provide a value behavior throughout the rehab process based on an analysis of the objectives comprising the rehab process.

According to further embodiment, the server 130 is further configured to provide a recommendation on the rehab order and objectives in order to optimize the value of the at least one REP. The recommendation is provided based on analysis of a plurality of rehabs made in a plurality of second REPs associated with the at least one REP and the after-rehab value (ARV) increase achieved respective thereof.

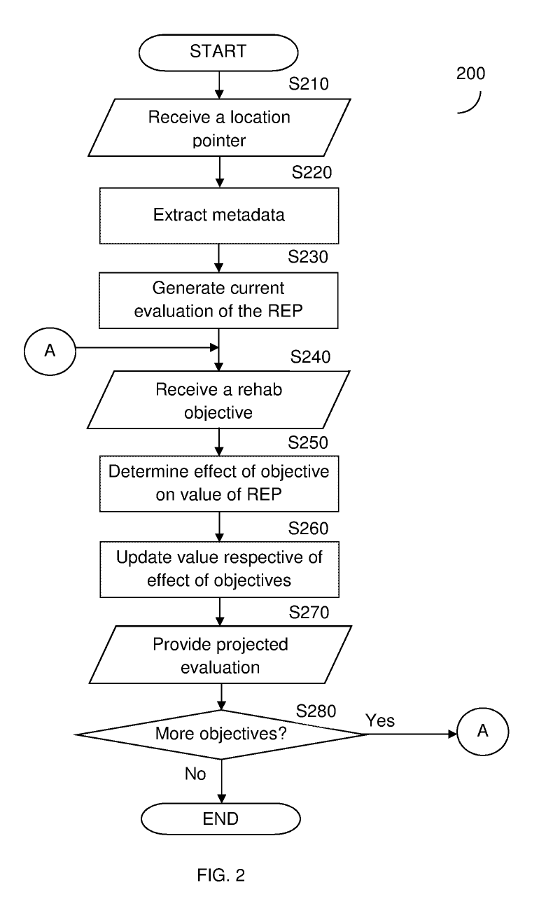

FIG. 2 depicts an example flowchart 200 describing a method for dynamically evaluating real estate properties throughout rehab processes according to an embodiment. At S210, the operation starts when at least one location pointer associated with an REP is received from a user device, for example, the user device 120-1. The location pointer may be, for example, an address, a geo-location, and similar parameters configured to locate a property.

At S220, metadata associated with the REP is identified. The metadata may include at least one of: parameters associated with previous one or more transactions made with respect to one or more second REPs in proximity to the at least one REP, previous transaction made with respect to the at least one REP, and the like. The metadata may be extracted from, for example, governmental website via the network 110, real estate comparison websites, such as, for example, Zillow®, combination thereof, and the like. The parameters may include sale price, date of sale, property taxes, and the like.

According to an embodiment, S220 may further include extraction of at least one multimedia content element associated with the at least one REP. The multimedia content element may be an overhead image of the location. The multimedia content element may be at least one image of a map associated with the REP. Such images may come from sources such as Google® maps and similar online sources. In an embodiment, a database is configured to store a plurality of earth map images. Thereafter, a surface outline of a surface, e.g., a rooftop of the REP, is identified. A pattern associated with the outlined surface is then determined by the server 130. S220 may further include identification of venues in proximity to the REP. The venues may include, for example, commercial venues, community venues, etc. The server 130 is further configured to determine the proximity of the venues to the REP.

Optionally, at S220, a subdivision in which the REP is located is identified. According to an embodiment, at least one view characteristic is further determined from the at least one REP respective of the multimedia content element as well as size parameters, e.g. square feet associated with the REP.

At S230, a current valuation of the at least one REP is generated. The current valuation is generated respective of the metadata extracted, as further descried hereinabove with respect to FIG. 1. At S240, at least one rehab objective is received. The rehab objective is a portion of a rehab process that effect the value of the at least one REP.

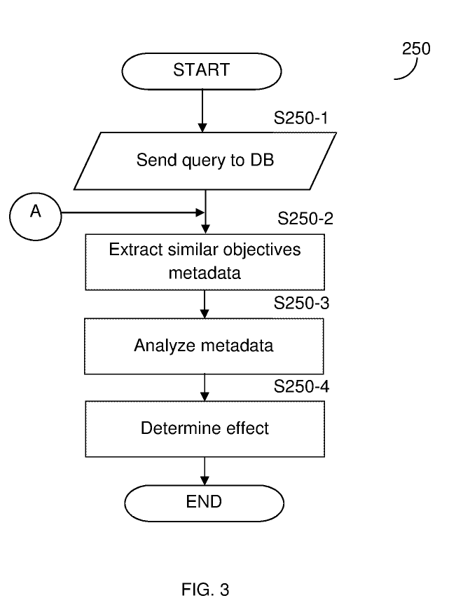

At S250, the effect of the objective process and completion on the value of the at least one REP is determined. The determination of the effect on the value is further described herein below with respect to FIG. 3.

At S260, the value of the at least on REP is updated with respect to the effect of the objective. At optional S270, the updated valuation is provided as an output. The output may include a numerical or graphical representation of the projected valuation caused to be displayed on a user device. At S280, it is checked whether additional are objectives received and if so, execution continues with S240; otherwise, execution terminates.

FIG. 3 depicts an example flowchart 250 describing a method for determining the effect of the objective process and completion on the value of the at least one REP. According to an embodiment. At S250-1, the operation starts when at least one query is sent to a database. The query comprises at least metadata associated with the REP and/or the objective and metadata associated therewith.

At S250-2, similar objectives for which the effect on value of REP are known, are extracted responsive to the query. The similar objectives may include objected completed on comparable REPs, e.g. rehab and renovation activities performed and completed on similar properties. At S250-3, the similar objectives are analyzed. At S250-4, the objective effect on the value of REP is determined respective of the analysis. The determination may include comparing the values of the comparable REP before and after an objective has been completed.

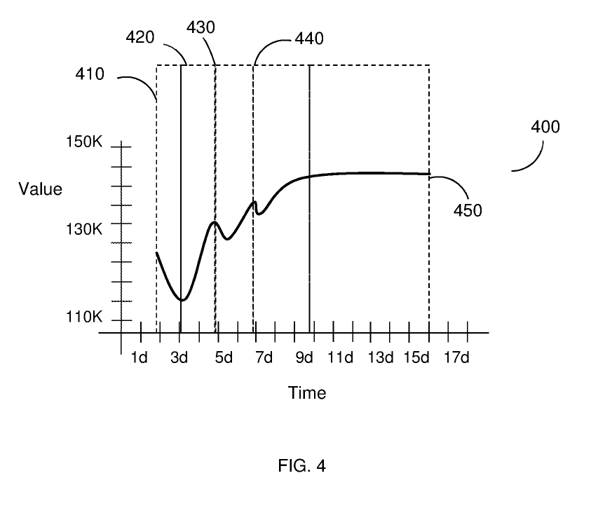

FIG. 4 is a graph 400 of a value behavior of a real estate property (REP) throughout rehab according to an embodiment. A graph 400 representing a dynamic behavior of the REP throughout the rehab process. The rehab process starts with demolition 410 wherein a decrease in the value of the REP occurs throughout the demolition. Upon installment of a new kitchen 420 in the REP value increases throughout the process and reaches a pick upon completion. Thereafter, a replacement of plumbing 430 takes place and there is a decrease throughout the installment and an increase upon completion. Then, new tiles are installed in a master bathroom 440 hence a small decrease and upon completion an increase. Upon completion of the rehab 450 the value remains stable. It should be clear that a plurality of objectives may occur simultaneously and in such cases an aggregation of the effect of each objective is generated.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining the value of a real estate property (REP) throughout a rehab process, comprising:
receiving at least one location pointer associated with the at least one REP;
extracting metadata associated with the at least one REP from at least one web source;
determining a current evaluation of the REP based on the extracted metadata;
receiving at least one rehab objective; and,
analyzing the at least one rehab objective to determine the effect of the at least one rehab objective on the value of the property.

2. The method of claim 1, further comprising:
determining a projected evaluation of the property based on the analysis.

3. The method of claim 1, wherein the metadata is at least one of: parameters associated with previous one or more transactions made with respect to one or more second REPs in proximity to the at least one REP, parameters associated with the at least one REP, and a combination thereof.

4. The method of claim 1, wherein determining the current evaluation of the REP further includes identifying venues located within a predefined distance to the REP based on the metadata.

5. The method of claim 1, wherein extracting metadata associated with the REP further includes extracting a multimedia content element associated with the REP.

6. The method of claim 5, wherein the multimedia element includes map images of the REP.

7. The method of claim 1, wherein the at least one web source includes at least one of: regulatory data sources, tax authorities, geographic information systems (GISs), real estate comparison websites, and home appliance retailers.

8. The method of claim 1, wherein the analyzing the at least one rehab objective includes determining comparable REPs to the at least one REP within a predetermined threshold, and extracting data associated with similar objectives for which the effect on the value is known.

9. The method of claim 1, further comprising:
recommending a rehab order and an objective order to optimize the value of the at least one REP.

10. The method of claim 1, further comprising:
causing the display of the projected valuation on a user device.

11. A non-transitory computer readable medium having stored thereon instructions for causing a processing circuitry to perform a process, the process comprising:
receiving at least one location pointer associated with the at least one REP;
extracting metadata associated with the at least one REP from at least one web source;
determining a current evaluation of the REP based on the extracted metadata;
receiving at least one rehab objective; and,
analyzing the at least one rehab objective to determine the effect of the at least one rehab objective on the value of the property.

12. A system for determining the value of a real estate property (REP) throughout a rehab process, comprising:
a processing circuitry; and
a memory, the memory containing instructions that, when executed by the processing circuitry, configure the system to:
receive at least one location pointer associated with the at least one REP;
extract metadata associated with the at least one REP from at least one web source;
determine a current evaluation of the REP based on the extracted metadata;
receive at least one rehab objective; and,
analyze the at least one rehab objective to determine the effect of the at least one rehab objective on the value of the property.

13. The system of claim 12, further comprising:
determining a projected evaluation of the property based on the analysis.

14. The system of claim 12, wherein the metadata is at least one of: parameters associated with previous one or more transactions made with respect to one or more second REPs in proximity to the at least one REP, parameters associated with the at least one REP, and a combination thereof.

15. The system of claim 12, wherein determining the current evaluation of the REP further includes identifying venues located within a predefined distance to the REP based on the metadata.

16. The system of claim 12, wherein extracting metadata associated with the REP further includes extracting a multimedia content element associated with the REP.

17. The system of claim 16, wherein the multimedia element includes map images of the REP.

18. The system of claim 12, wherein the at least one web source includes at least one of: regulatory data sources, tax authorities, geographic information systems (GISs), real estate comparison websites, and home appliance retailers.

19. The system of claim 12, wherein the analyzing the at least one rehab objective includes determining comparable REPs to the at least one REP within a predetermined threshold, and extracting data associated with similar objectives for which the effect on the value is known.

20. The system of claim 12, further comprising:
recommending a rehab order and an objective order to optimize the value of the at least one REP.
